(19) United States
(12) Patent Application Publication
(10) Pub. No.: US 2026/0036125 A1
(43) Pub. Date: Feb. 5, 2026

(54) COMPOSITE SLUG-BEARING FOR GEAR PUMPS

(71) Applicant: Roper Pump Company LLC, Commerce, GA (US)

(72) Inventor: Michael Andrew Ingram, Oakwood, GA (US)

(21) Appl. No.: 19/279,261

(22) Filed: Jul. 24, 2025

Related U.S. Application Data
(60) Provisional application No. 63/677,472, filed on Jul. 31, 2024.

(51) Int. Cl. F04C 2/14; F16C 35/08

(52) U.S. Cl. CPC F04C 2/14; F16C 35/08; F04C 2230/85; F04C 2240/52; F16C 2360/00

(57) ABSTRACT

Systems and methods described herein provide composite slug-bearings to support rotating shafts and provide for adaptable pump configurations in a positive-displacement pump. A main bearing surface is configured to make direct contact with the rotating shaft and may be in the form of a rolling element bearing, plain journal bearing, or flanged journal bearing. A slug houses the main bearing surface and serves to occupy volume within the pump housing. The slugs are also used to locate and/or position the bearing within the housing, which will position the shafts. Multiple composite slug-bearings may be interchangeably located within the gear chamber of a pump for proper shaft placement. The composite slug-bearings also affect the volumetric displacement of the pump. The size of the slug is selected to allow relatively smaller gears to operate within a relatively larger housing while still maintaining the minimal clearances that are required for positive-displacement machines.

### CROSS-REFERENCE TO RELATED APPLICATION

This application claims priority to under 35 U.S.C. § 119, based on U.S. Provisional Application No. 63/677,472, filed Jul. 31, 2024, titled “Composite Slug-Bearing for Gear Pumps,” the disclosure of which is hereby incorporated by reference.

### BACKGROUND

In pumps, such as gear pumps and many other rotary machines, bearings are used to support shafts(s) while still allowing them to rotate freely. Traditionally, shaft support bearings (rolling element bearings, plain journal bearings, flanged journal bearings, etc.) are mounted directly to the pump housing, typically in the endplates. The main function of the bearing is to support the shaft.

### BRIEF DESCRIPTION OF THE DRAWINGS

FIG. 1 is a side perspective view of a gear pump in which composite slug-bearings may be implemented;

FIG. 2 is a side cross-section view of a gear pump with composite slug-bearings, according to an implementation;

FIG. 3A is a simplified end view of a gear pump main casing, according to an implementation;

FIG. 3B is a simplified end view of the gear pump main casing with a set of composite slug-bearings installed, according to an implementation;

FIGS. 4A and 4B are simplified side cross-sectional views of a pump in a base configuration and a high-pressure configuration, respectively, according to different implementations;

FIGS. 5A and 5B are simplified side cross-sectional views of a pump in an inward-facing bearing configuration and an outward-facing bearing configuration, respectively, according to different implementations;

FIGS. 6A and 6B are front and rear perspective views of a composite slug-bearing, according to an implementation;

FIG. 6C is a cutaway of the rear perspective views of FIG. 6B;

FIGS. 7A-7C are front, rear, and side cross-sectional views, respectively, of a slug for a composite slug-bearing, according to an implementation;

FIGS. 8A and 8B are front perspective and cutaway views of a composite slug-bearing, according to another implementation;

FIG. 9 is a simplified end view of a set of composite slug-bearings oriented for installation in a gear chamber, according to another implementation; and

FIG. 10 is a flow diagram of a process for modifying the configuration of a gear pump, according to an implementation described herein.

### DETAILED DESCRIPTION

The following detailed description refers to the accompanying drawings. The same reference numbers in different drawings may identify the same or similar elements. Also, the following detailed description does not limit the invention.

Gear pumps may be designed for certain specifications to meet a required capacity, flow rate, pressure, etc. For example, gear pumps may be provided with different physical sizes and/or configurations to meet different specifications. When pumping requirements change, a user/entity may need to change to a gear pump with different specifications. However, when installed in a system, changes to a pump footprint or outer configuration (e.g., housing size, connection locations, etc.) can cause cascading changes throughout the system. Thus, it would be beneficial to provide a gear pump with adaptable specifications (different pressures, different flow rates, etc.) and a consistent outer configuration that can connect in a legacy system with minimal changes.

Bearings and exposed surfaces of an internal gear chamber may wear more quickly when pumped fluids include particles and/or contaminants. Typically, higher wear-resistant and expensive materials are required for such applications. Operating a pump at higher pressures can further increase wear rates. Particularly, a pump that is reconfigured to operate with different fluids and/or at higher pressures may also require different bearing materials and configurations to withstand potential increased wear. Thus, it would be beneficial to provide a gear pump with adaptable specifications that can sustain performance under high-wear conditions.

Systems and methods described herein provide composite slug-bearings to support rotating shafts and provide for adaptable pump configurations in a positive-displacement pump. A main bearing surface is configured to make direct contact with the rotating shaft and may be in the form of a rolling element bearing, plain journal bearing, flanged journal bearing, or the like. A slug houses the main bearing surface and serves to occupy volume within the pump housing. The slugs can also be used to locate and/or position the bearing within the housing, which will position the shafts. Multiple composite slug-bearings may be interchangeably located within the gear chamber of a pump for proper shaft placement.

The composite slug-bearings may be used not only to support the shaft, but also to affect the volumetric displacement of the pump. The size of the slug can be altered (e.g., along an axial length of the shaft) to allow relatively smaller gears to operate within a relatively larger housing while still maintaining the minimal clearances that are required for positive-displacement machines. In some implementations, as described further herein, the composite slug-bearings may be used to provide higher pressure capabilities in a pump by supporting the pump shafts in locations closer to the gears.

According to an implementation, a composite slug-bearing for a gear pump includes a slug having a bore formed along an axis and a bearing disposed at least partly within the bore. The bearing may be configured to support a rotating shaft. The slug includes an outer perimeter configured to match a curved portion of an inner perimeter of an internal gear chamber of the pump. The composite slug-bearing may be configured to be interchangeably positioned facing upward or downward and inward or outward within the internal gear chamber to support the rotating shaft.

According to another implementation, a system for a gear pump includes a first gear mounted for rotation on a first shaft (e.g., a drive shaft), a second gear mounted for rotation on a second shaft (e.g., an idler shaft), and a first bearing assembly, and a second bearing assembly. The first bearing assembly may be configured to support the first shaft within the internal gear chamber of the gear pump. The first bearing assembly may include a first bearing and a first slug having a first bore along a first axis and a first outer perimeter. The first bearing may be disposed at least partly within the first bore. Similarly, the second bearing assembly may be configured to support the second shaft within the internal gear chamber The second bearing assembly may include a second bearing and a second slug having a second bore along a second axis and a second outer perimeter. The second bearing may be disposed at least partly within the second bore. The first outer perimeter and the second outer perimeter may be mated to collectively match curved portions of an inner perimeter of the internal gear chamber.

According to still another implementation, a pump includes a main case having an internal gear chamber with a suction port and a discharge port, an endplate secured to a first side of the main case, and a backplate assembly secured to a second side of the main case. The pump may also include a bearing system removably disposed within the internal gear chamber. The bearing system may include a first slug and a second slug, each slug including a bore along an axis. The first slug may include a first bearing disposed at least partly within its bore. A drive shaft may be configured to extend through the internal gear chamber into the bores of the first and second slug. The first slug and the second slug each include an outer perimeter, in a plane orthogonal to the axis, that is configured to match a curved portion of an inner perimeter of the internal gear chamber.

According to yet another implementation, a method for reconfiguring a gear pump is provided. The method includes disconnecting an endplate from a main case of the gear pump, removing internal components from a gear chamber of the main case, and selecting a replacement assembly for a desired volume and pressure rating. The replacement assembly may include a first gear mounted for rotation on a first shaft, a second gear mounted for rotation on a second shaft, a first bearing assembly configured to support the first shaft within the gear chamber, and a second bearing assembly configured to support the second shaft within the gear chamber. The method may also include inserting the replacement assembly into the gear chamber of the main case and securing the backplate assembly to the case.

As used herein, the terms “upper” and “lower,” “top” and “bottom,” “inward” and “outward,” “front” and “back,” and other like terms indicating relative positions to a given point or element are utilized to more clearly describe some elements. Such terms are not intended to limit embodiments to any particular orientation.

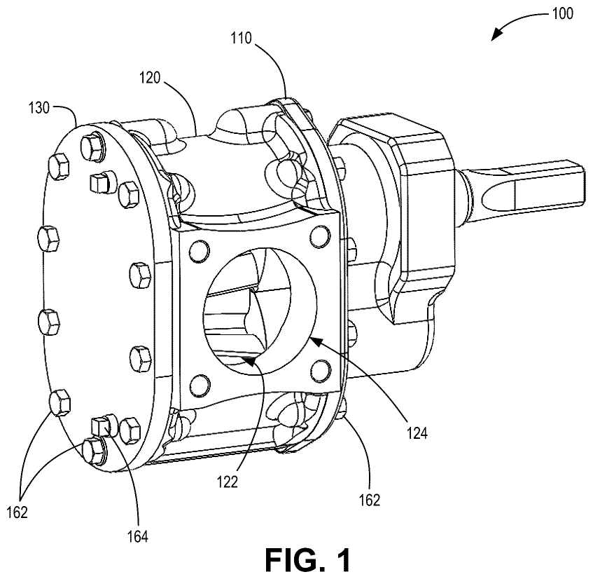

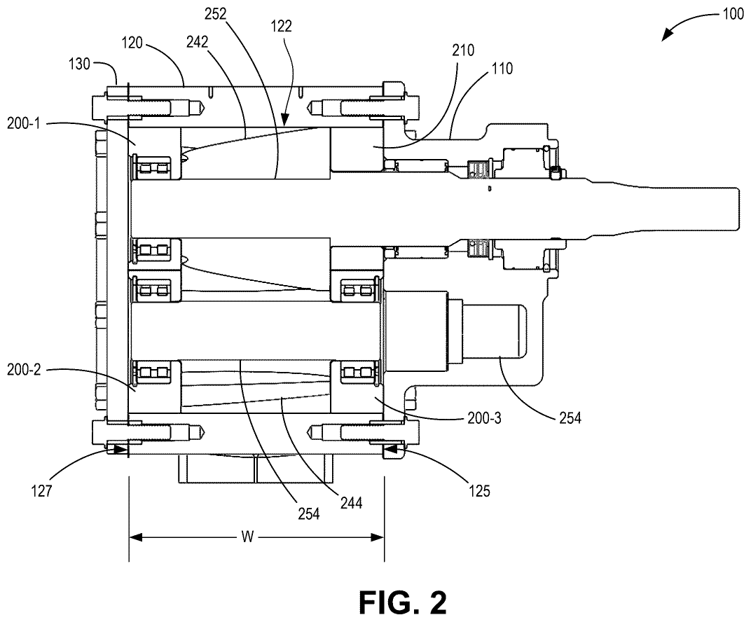

Exemplary embodiments for a pump 100 with modular composite slug-bearings 200 are described with reference to FIGS. 1 and 2. FIG. 1 is a side perspective view of pump 100, while FIG. 2 is a side cross-sectional view of pump 100 with composite slug-bearings 200 installed. As shown in FIG. 1, pump 100 may include a backplate 110, a main case 120, and an endplate 130. As shown in FIG. 2, and described further herein, pump 100 may be equipped with composite slug-bearings 200-1, 200-2, and 200-3 (referred to collectively as “composite slug-bearings 200” and generically as “composite slug-bearing 200”). According to an implementation, each of composite slug-bearings 200-1, 200-2, and 200-3 may have identical or substantially identical configurations.

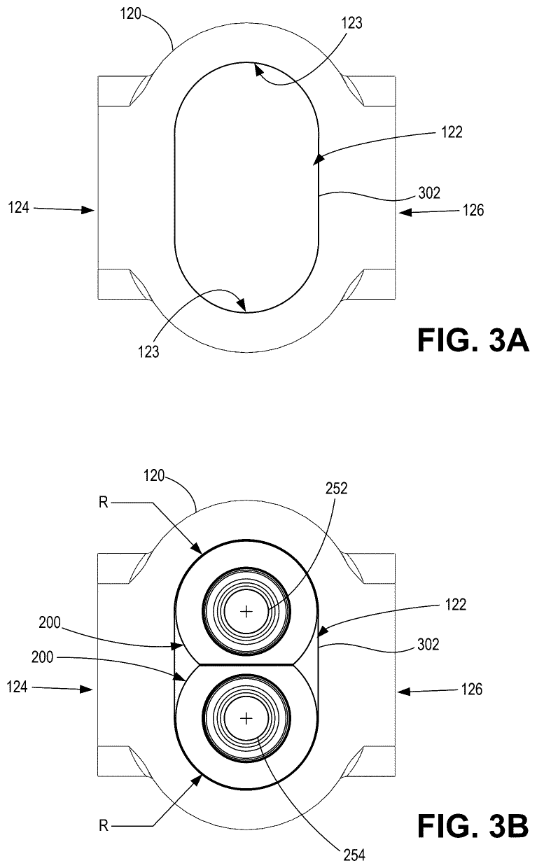

Referring collectively to FIGS. 1 and 2, main case 120 includes a gear chamber 122 with apertures in fluid communication with a suction port 124 and a discharge port (126, FIG. 3A). Main case 120 may include a front surface 125 and a rear surface 127 to which backplate 110 and endplate 130, respectively, may attach. In one implementation, backplate 110 and main case 120 may be bolted together, and endplate 130 and main case 120 may be bolted together. Bolts 162 and alignment pins 164 may be used, for example, to align and secure backplate 110 and endplate 130 to main case 120.

Main case 120 may be formed (e.g., cast, machined, etc.) as a single piece or may be formed by joining multiple body sections to form gear chamber 122. Gear chamber 122 may be enclosed on either end by backplate 110 and endplate 130, respectively.

Backplate 110 (also referred to as a backplate assembly) may include a structure to close off another side of main case 120, at surface 125, while supporting drive shaft 252. Backplate 110 may include a set of bolt holes (not shown) near the periphery of backplate 110 and extending longitudinally (e.g., substantially parallel to shafts 252/254) through backplate 110. Main case 120 may include a set of connection holes (not shown) opening at surface 125 and extending at least partially into main case 120 from surface 125 toward surface 127. Bolts 162, inserted through the bolt holes into connection holes, connect backplate 110 to main case 120. In one implementation, main case 120 and backplate 110 may be bolted together and sealed using a compressible gasket (not shown) therebetween.

Endplate 130 may include a structure to close off another side of main case 120, at surface 127. In one implementation, endplate 130 may include a substantially flat plate. Endplate 130 may be configured to be removed for extraction of composite slug-bearings 200 and the shafts 252/254. Endplate 130 may include a set of bolt holes (not shown) near the periphery of endplate 130 and extending longitudinally through endplate 130. Main case 120 may include a set of connection holes (not shown) opening at surface 127 and extending at least partially into main case 120 from rear surface 127 toward the front surface 125. Bolts 162, inserted through the bolt holes into connection holes, connect endplate 130 to main case 120. In one implementation, main case 120 and endplate 130 may be bolted together and sealed using a compressible gasket (not shown) therebetween.

Suction port 124 and the discharge port 126 are not limited by their size or shape, and their locations may be generally on opposite sides of gear chamber 122 or in perpendicular planes somewhere between front surface 125 and rear surface 127. Spaced apertures in gear chamber 122 register with suction port 124 and the discharge port, with suction port 124 being open to an inlet passage of pump 100, and the discharge port 126 being open to an outlet passage of pump 100.

Main casing 120 may be configured to contain a set of gears 242 and 244 and a corresponding set of shafts 252 and 254. Gear 242 (sometimes referred to as a drive gear) is mounted for rotation about a drive shaft or axle 252 at its center. Gear 244 (sometimes referred to as an idler gear) is similarly mounted for rotation about an idler shaft 254. Shafts 252 and 254 may each extend through chamber 122 in parallel. In the configuration of FIGS. 1-3B, drive shaft 252 may be supported on one side of gear 242 by backplate 110 and on an opposite side of gear 242 by a composite slug-bearing 200-1. Idler shaft 254 may be supported on one or both sides of gear 244 by a set of composite slug-bearing 200-2 and 200-3. Shaft 252 and shaft 254 may each be made of the same material, such as steel or another rigid material.

Gears 242 and 244 may have peripheral teeth that intermesh so that the rotation of one of the gears causes rotation of the other gear. Thus, the rotation of one of the gears (e.g., gear 242) by drive shaft 252 causes rotation of the other gear (e.g., gear 244) about shaft 254. The teeth of gears 242 and 244 may have uniform sizes and may be machined to intermesh for all angular positions in a rotation of the gears 242, 244. Gears 242 and 244 may have helically oriented teeth (as illustrated herein), herringbone gear teeth, or straight spur teeth, although implementations are not limited to these shapes. Gears 242 and 244 may be formed of a material such as cast iron, steel, ceramic, plastic, a composite, etc. As described further in connection with FIGS. 3A and 3B, gears 242 and 244 may be formed to provide a profile with a radius of curvature nearly equal to the radius of curvature (R) of rounded wall sections within portions of gear chamber 122.

The axial length of gears 242 and 244 may extend partly across the width (W) of chamber 122, as shown in FIG. 2, with composite slug-bearings 200 or an optional conventional slug 210 extending along the rest of the width of chamber 122. The axial length of gears 242 and 244 may be equal, and the axial length of composite slug-bearings 200-1 and 200-2 may also be equal. In the implementation of FIGS. 1 and 2, the axial length of composite slug-bearings 200-3 may be equal to the axial length of slug 210.

Thus, gear 242 or 244 and composite slug-bearings 200 together extend axially for a distance equal to the width, W, of chamber 122. More particularly, the combined axial lengths of gear 242, composite slug-bearing 200-1, and slug 210 may span the entire width of chamber 122. Similarly, the combined axial length of gear 244, composite slug-bearings 200-2, and composite slug-bearings 200-3 may also span the entire width of chamber 122. The axial lengths of composite slug-bearings 200-1/slug 210 may be the same or different than the axial lengths of composite slug-bearing 200-2/200-3. In other words, gears 242 and 244 may not necessarily be centered within chamber 122. Generally, a longer axial length of gears 242/244 supports comparatively lower pressure ratings for pump 100 with higher fluid transfer capacity. Conversely, a shorter axial length of gears 242/244 supports higher pressure ratings for pump 100 with lower fluid transfer capacity.

FIG. 3A is a simplified end view of main casing 120, and FIG. 3B is a simplified end view of main casing 120 with a set of composite slug-bearings 200 installed, according to an implementation. Referring to FIGS. 3A and 3B, composite slug-bearings 200 may be formed to provide a profile with a radius of curvature, R, nearly equal to the radius of curvature of rounded wall sections 123 along the perimeter of chamber 122. For example, chamber 122 may have a stadium or obround perimeter 302 measured in a direction orthogonal to an installed shaft and composite slug-bearings 200 may have a geometrically similar perimeter that matches rounded wall sections 123. Similarly, gears 242/244 (not visible in FIGS. 3A/3B) may have a radius of curvature nearly equal to the radius of curvature of rounded wall sections 123 of chamber 122. That is, the major diameter of gears 242/244 may be equal to, or nearly equal to, a perimeter radius, R, of composite slug-bearings 200. Composite slug-bearings 200 may be interchangeably positioned facing upward and downward within gear chamber 122 to support shafts 252/254.

Referring collectively to FIGS. 1-3B, during operation, fluid is drawn from suction port 124 into chamber 122. Particularly, gears 242 and 244 intermesh during rotation to draw in fluid near suction port 124. As gears 242/244 rotate, fluid is trapped in cavities between the teeth and the rounded wall sections 123 of chamber 122. Each gear 242/244 may be aligned or otherwise configured to provide a continuous seal at rounded wall sections 123 along a portion of the width W (FIG. 2) of chamber 122 to prevent slippage. Thus, fluid may be transported to the discharge side, where intermeshing of the gears compresses the respective cavities and forces fluid out through the discharge port 126.

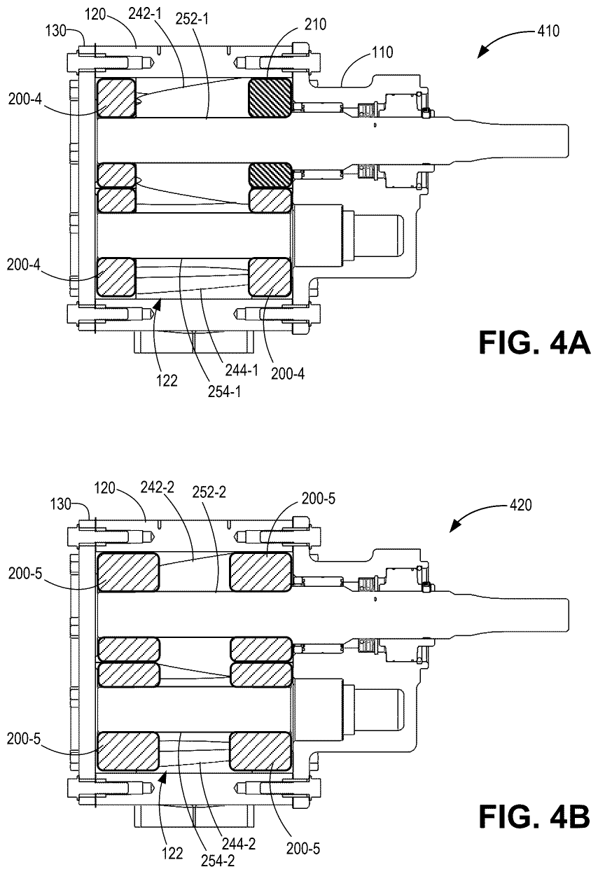

The properties of pump 100 may be modified by adjusting a ratio of the respective axial lengths of composite slug-bearings 200 and gears 242/244. According to an implementation, composite slug-bearings 200, gears 242/244, and shafts 252/254 may be provided as kits or modules of different sizes. For example, as shown in FIGS. 4A and 4B, a kit may be provided to convert pump 100 from a base configuration to a higher-pressure configuration. FIGS. 4A and 4B are simplified cross-sectional views of pump 100 in a base configuration 410 and a high-pressure configuration 420, respectively. The base configuration 410 of pump 100 may include comparatively shorter composite slug-bearings 200-4 with longer gears 242-1/244-1 mounted on shafts 252-1/254-1, as shown in FIG. 4A. Furthermore, base configuration 410 may include a conventional slug 210 along drive shaft 252 adjacent to backplate 110. No bearing may be necessary at slug 210 since a bearing may be included within backplate 110.

As shown in FIG. 4B, a conversion kit may provide a high-pressure configuration 420 with comparatively longer composite slug-bearings 200-5 and shorter gears 242-2/244-2 (than used in configuration 410) mounted on shafts 252-2/254-2. The composite slug-bearings 200-5 may decrease the effective volume of chamber 122 to enable pump operations at higher pressures with lower fluid volumes. For example, in the illustrated change from configuration 410 to configuration 420, flow rates may be reduced by about 50% and pressure ratings may be increased by about 60%. Furthermore, slug 210 of configuration 410 may be replaced with a composite slug-bearing 200-5 in high-pressure configuration 420, thus providing a bearing closer to drive gear 242-2 for supporting higher pressures. Pressure ratings and flow rates may vary for particular applications and may be limited by other design parameters or service parameters.

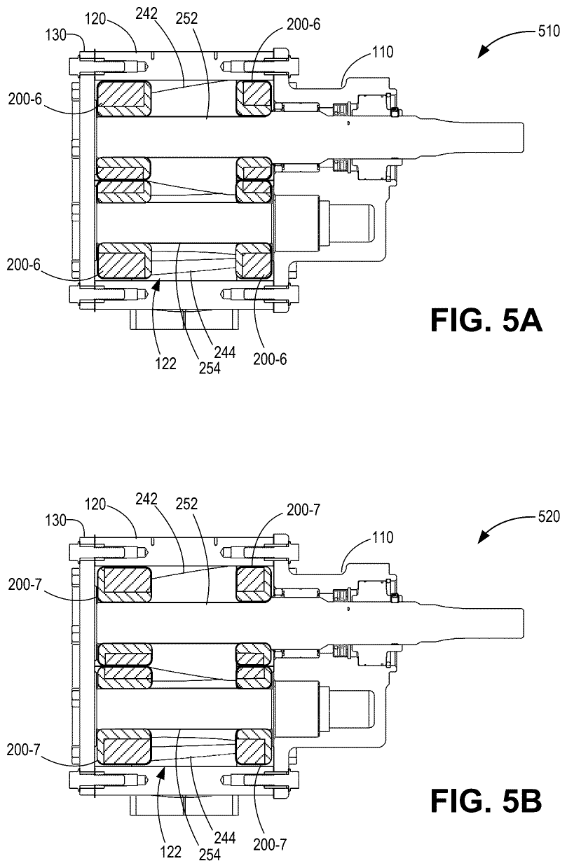

According to another implementation, the properties of pump 100 may be modified by adjusting an orientation of composite slug-bearings 200 and gears 242/244. For example, as shown in FIGS. 5A and 5B, composite slug-bearings 200 may be oriented facing either toward or away from gears 242/244. FIGS. 5A and 5B are simplified cross-sectional views of pump 100 in an inward-facing bearing configuration 510 and an outward-facing bearing configuration 520, respectively.

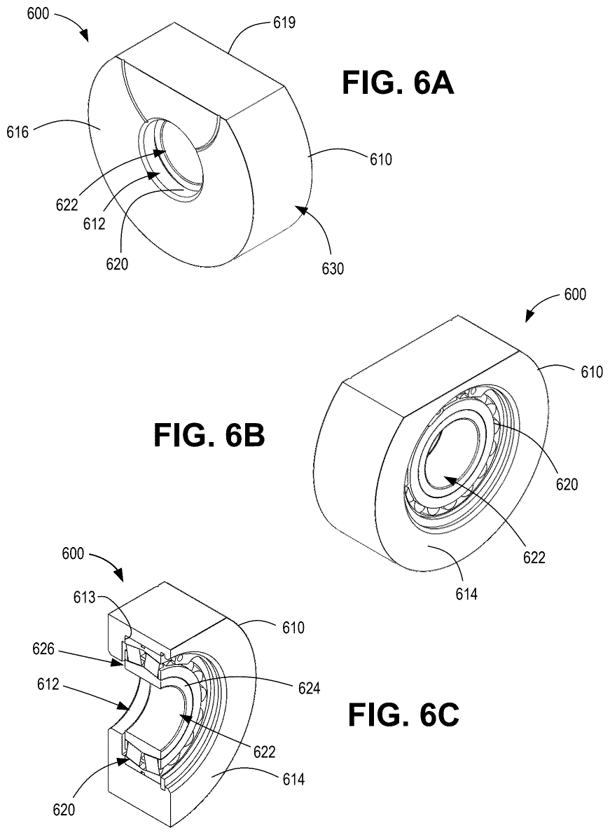

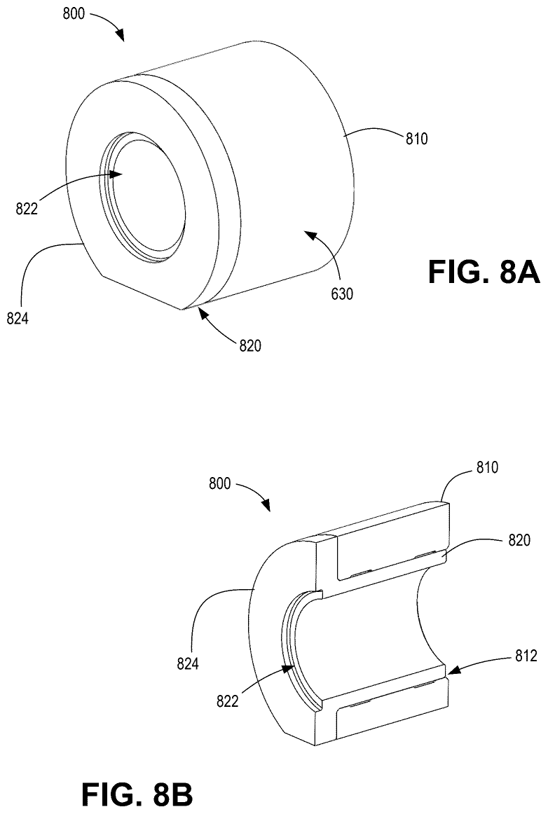

The inward-facing configuration 510 of pump 100 may expose some surfaces of bearings (e.g., bearings 620, 820 described further herein in FIGS. 6A and 8A) to fluids entering and exiting chamber 122, as shown in FIG. 5A. Depending on the type and configuration of bearing used in composite slug-bearing 200-6, inward-facing bearing surfaces may be used to shield the slug material from abrasives, heat, or other conditions that may reduce performance/lifecycle. In another implementation of inward-facing configuration 510, the slug may be made of a high thermally-conductive material to draw heat away from the bearing of composite slug-bearing 200-6. In still another implementation of inward-facing configuration 510, the slug material may also be made of a material that is less expensive than the sleeve material, which could decrease the overall cost of each composite slug-bearings 200.

In the outward-facing configuration 520 of pump 100, the slugs (e.g., slug 610, FIGS. 6A-6C) of each composite slug-bearing 200-7 may shield bearings (e.g., bearings 620, FIG. 6A) from fluids entering and exiting chamber 122, as shown in FIG. 5B. Depending on the type and configuration of bearing used in composite slug-bearing 200-7, slug material may protect outward-facing bearings from abrasives, heat, or other conditions that may reduce performance/lifecycle.

As described further herein, the components for configurations 410/420 and 510/520 (e.g., composite slug-bearings 200, slug 210, gears 242/244, and/or shafts 252/254) may be changed out by removing endplate 130 to access chamber 122. Thus, operating parameters of pump 100 can be modified without changing the pump footprint or outer configuration (e.g., housing size, connection locations, etc.).

FIGS. 6A, 6B, and 6C illustrate composite slug-bearing 600, according to an implementation. Composite slug-bearing 600 may correspond to one embodiment of composite slug-bearing 200. FIG. 6A is a front perspective view of composite slug-bearing 600, FIG. 6B is a rear perspective view of composite slug-bearing 600, and FIG. 6C is a cutaway view of the rear perspective of FIG. 6B. In the configuration of FIGS. 6A-6C, composite slug-bearing 600 may include a slug 610 with a bore 612, and a bearing 620 inserted into bore 612.

Slug 610 may position a bearing 620 at a selected location and orientation within gear chamber 122. Particularly, slug 610 may position a bearing 620 to receive a portion of a shaft (e.g., shaft 252/254). Bearing 620 may include, for example, a rolling element bearing or a plain journal bearing. Bearing 620 may include a shaft support bore 622. Bearing 620 generally may support a shaft (e.g., shaft 252/254) in shaft support bore 622 while allowing the shaft to rotate freely.

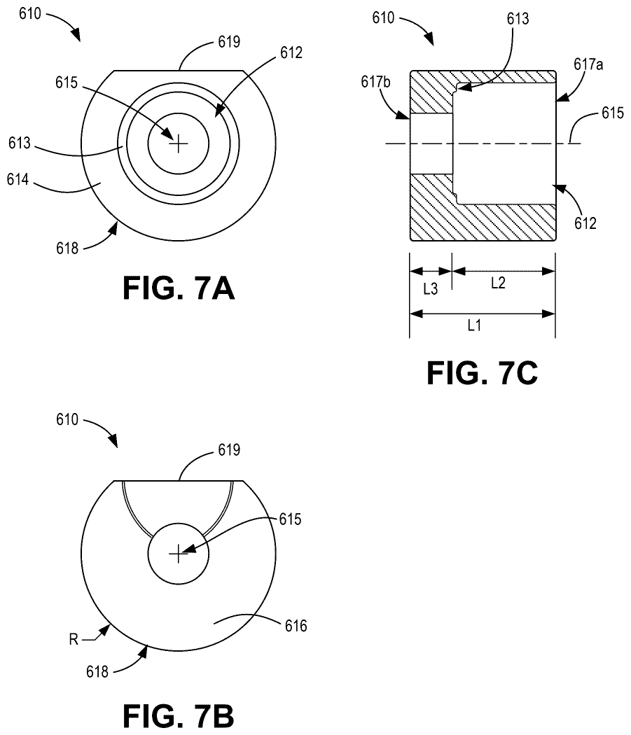

FIGS. 7A, 7B, and 7C show a front view, a rear view, and a side cross-sectional view, respectively, of slug 610 according to an implementation. Slug 610 may include a front surface 614 and a rear surface 616 with bore 612 extending between surfaces 614 and 616.

Slug 610 may include a substantially circular perimeter 618, in a direction orthogonal to an axis 615 of bore 612, and a straight side or surface 619. According to an implementation, the perimeter 618 of slug 610 may be configured such that surface 630 of slug 610 may fit against the portion of perimeter 302 formed by curved walls 123 (e.g., an arc of about 180 degrees along each curved wall 123) of gear chamber 122. Slug 610 may be configured to fill a portion of volume within gear chamber 122. For example, in one implementation shown in FIG. 3B, slug 610 may be configured such that a perimeter of two slugs 610, when mated along straight surface 619, match the major diameters of a set of meshed gears 242/244. The interface of slugs 610 at corresponding surfaces 619 may prevent rotation of composite slug-bearings 600 within chamber 122.

Bore 612 may be configured to accept bearing 620 within at least a portion of bore 612. As shown in FIG. 7C, bore 612 may have a length, L1, that corresponds to the width of slug 610. Bore 612 may include a shoulder 613 that divides L1 of bore 612 into a larger diameter portion 617a and a smaller diameter portion 617b. The larger diameter portion 617a of bore 612 may be configured with a diameter to hold bearing 620. The smaller diameter portion 617b may be sized with a diameter to receive a shaft of a gear pump, and may generally correspond to a diameter of shaft support bore 622 in bearing 620.

The length, L2, of larger diameter portion 617a may be substantially the same as an axial length of bearing 620. More particularly, bearing 620 may set within larger diameter portion 617a such that a front surface 624 (FIG. 6C) of bearing 620 is near front surface 614 when a rear surface 626 (FIG. 6C) of bearing 620 contacts shoulder 613. Thus, L2 may generally be a fixed length determined based on the size of bearing 620 selected for required pump parameters. In one implementation, bearing 620 may be secured within larger diameter portion 617a via a retaining ring or other fixation mechanism.

Length L1, and correspondingly length L3, may be selected/configured to fill a volume in gear chamber 122. When composite slug-bearings 600 are installed within gear chamber 122, increasing the length L1 results in a corresponding reduction in the effective fluid volume of gear chamber 122.

FIGS. 8A and 8B illustrate a composite slug-bearing 800, according to another embodiment of a composite slug-bearing 200. FIG. 8A is a front perspective view of composite slug-bearing 800, and FIG. 8B a cutaway view of the front perspective of FIG. 8A. In the configuration of FIGS. 8A and 8B, composite slug-bearing 800 may include a slug 810, including a bore 812, and a bearing 820 inserted into bore 812.

Similar to slug 610, slug 810 may position bearing 820 at a selected location and orientation within gear chamber 122. Particularly, slug 810 may position a bearing 820 to receive a portion of a shaft (e.g., shaft 252/254). Also similar to slug 610, slug 810 may include a substantially circular perimeter with a straight side. Slug 810 may be configured such that a perimeter of two slugs 810, when mated along the straight sides, match the major diameters of a set of meshed gears 242/244. Slug 810 may also include a bore 812, such as a substantially straight bore, to receive shaft support bore 822 of bearing 820. In one implementation, shaft support bore 822 may be press-fit into bore 812.

Bearing 820 may include, for example, a flanged journal bearing. Bearing 820 may include a shaft support bore 822 and a flange 824. Bearing 820 generally may support a shaft (e.g., shaft 252/254) in shaft support bore 822 while allowing the shaft to rotate freely. Flange 824 may have a matching perimeter to that of slug 810. Thus, flange 824 may cover a front surface of slug 810 (e.g., a surface in a plane orthogonal to an axis of the bores 812/822).

Composite slug-bearings 800 may be implemented, for example, in any of configurations 410/420 and 510/520 described above. When composite slug-bearing 800 is installed in gear chamber 122 in an inward-facing configuration 510 (e.g., FIG. 5A), flange 824 may protect slug 810 from fluids entering and exiting chamber 122. In one implementation, bearing 820 may be formed from an abrasive-resistant material, such as tungsten carbide, while slug 810 can be made of a material with high thermal conductivity, such as carbon. Thus, composite slug-bearing 800 may provide improved abrasion resistance with rapid heat dissipation. In other implementations, composite slug-bearing 800 may use different combinations of materials to achieve other advantages, such as reduced cost, higher pressure capacities, corrosion resistance, etc.

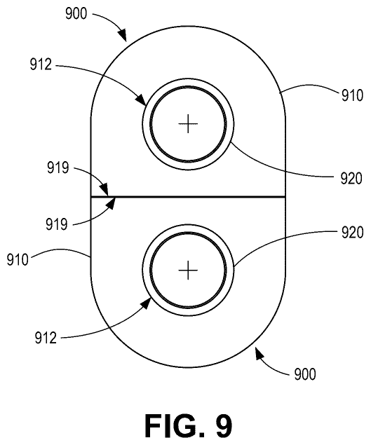

FIG. 9 illustrates a set of composite slug-bearings 900, according to another embodiment of composite slug-bearing 200. More particularly, FIG. 9 is a simplified end view a set of composite slug-bearings 900 oriented for installation in gear chamber 122. Similar to composite slug-bearings 800 described above, composite slug-bearings 900 may include a slug 910 with a bore 912, and a bearing 920 inserted into bore 912.

Composite slug-bearings 900 may be formed to provide a profile that fits with the perimeter of chamber 122 (e.g., FIG. 3A). For example, composite slug-bearings 900 may be configured such that a perimeter of two slugs 910, when mated along straight surfaces 919, is geometrically similar to perimeter 302 (e.g., an inner perimeter) of chamber 122 (FIG. 3A). In FIG. 9, composite slug-bearing 900 are shown with bearings 920 as plain journal bearings. In other implementations, the configuration of composite slug-bearing 900 may be implemented with rolling element bearings (e.g., FIG. 6A-C), or flanged journal bearings (e.g., FIGS. 8A and 8B) consistent with descriptions above. Composite slug-bearings 900 may be implemented in any of configurations 410/420 and 510/520 described above.

FIGS. 1-9 illustrate an example arrangement of pump 100 with modular composite slug-bearings 200. In other implementations, a different configuration of composite slug-bearings 200 may be used. For example, in another implementation, bearings 620, 820, or 920 may be mounted within a single slug that has perimeter similar to the combined perimeter of two mated composite slug-bearings shown in FIG. 3B or FIG. 9.

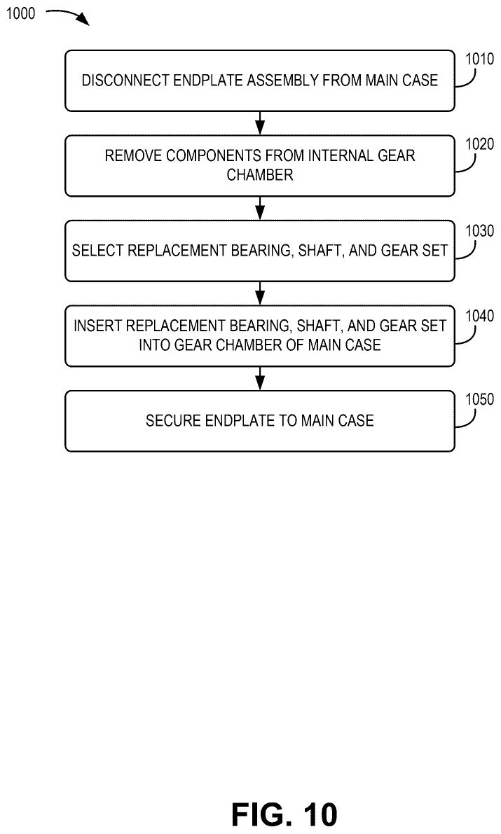

FIG. 10 is a flow diagram of a process 1000 for modifying a gear pump with composite slug-bearings 200, according to an implementation described herein. For purposes of illustration, process 1000 is described in the context of converting gear pump 100 from a base configuration 410 (FIG. 4A) to a high-pressure configuration 420 (FIG. 4B).

Process 1000 may include disconnecting an endplate assembly from the main case of a gear pump (block 1010) and removing components from the internal chamber of the main case (block 1020). For example, a technician may remove bolts 162 and alignment pins 164 from endplate 130 and remove endplate 130 from main case 120 of pump 100. The technician may then remove the existing bearing, shaft, and gear set (e.g., composite slug-bearings 200-4, slug 210, gears 242/244, and shafts 252/254 of base configuration 410) from gear chamber 122 of main case 120. In one implementation, the technician may also detach backplate 110 from main case 120 to facilitate removal of the shaft and gear set.

Process 1000 may further include selecting a replacement bearing, shaft, and gear set (block 1030) and inserting the replacement bearing, shaft, and gear set into the gear chamber of the main case (block 1040). For example, a technician may select a replacement bearing, shaft, and gear set (e.g., composite slug-bearings 200-5, gears 242-2/244-2, and shafts 252-2/254-2 from a number of possible replacements for high-pressure configuration 420) corresponding to the size of pump 100/chamber 122 and/or the operating parameters of the desired pump 100. In some implementations, different bearing, shaft, and gear arrangements (e.g., as described above in connection with FIGS. 4A-5B) may be available to provide a selected pressure and/or volumetric displacement rating for pump 100. Gears 242-2 and 244-2 may be interleaved (e.g., teeth intermeshed), and the replacement bearing, shaft, and gear set may be slid or inserted into chamber 122 of main case 120 with the leading ends of drive shaft 252-2 and, optionally, idler shaft 254-2 extending into bores of backplate 110. In one implementation, the technician may detach backplate 110 from main case 120 to facilitate insertion of drive shaft 252-2 and idler shaft 254-2 and then reconnect backplate 110 to main case 120. When fully inserted, composite slug-bearings 200-6 and the trailing ends of shafts 252-2 and 254-2 may be substantially flush with surface 127.

Process 1000 may also include securing the backplate assembly to the main case (block 1050). For example, a technician may insert alignment pins 164 through alignment holes of endplate 130 and into alignment holes of main case 120 to align main case 120 and endplate 130. Bolts 162 may be inserted through the bolt holes to secure the components together.

Installation of the replacement components into a gear pump in a modular manner as described above may provide different pressure ratings and flow rates from the originally configured gear pump. Using similar steps to those above, users have the option to re-install the original components and return the pump to the original flow rate and pressure ratings, if needed for a particular application.

FIG. 10 describes a process for modifying a pump, with a substantially flat endplate, using a replacement bearing, shaft, and gear set. In other implementations, composite slug-bearings 200 may also be used to modify a pump with a conventional backplate (i.e., a backplate that includes bores and bearings to support one or more shafts). For example, after replacement components (e.g., composite slug-bearings 200-6, gears 242-2/244-2, and shafts 252-2/254-2 for high-pressure configuration 420) are inserted into the gear chamber, the conventional backplate may be replaced with endplate 130. In other implementations, the conventional backplate may be used to enclose chamber 122 and secure the replacement components. In still other implementations, a retrofit kit (e.g., including composite slug-bearings 200-5, gears 242-2/244-2, and shafts 252-2/254-2 for high-pressure configuration 420) may replace a set of shafts and gears in a conventional gear pump to provide a high-pressure configuration.

The foregoing description of exemplary implementations provides illustration and description but is not intended to be exhaustive or to limit the embodiments described herein to the precise form disclosed. Modifications and variations are possible in light of the above teachings or may be acquired from practice of the embodiments. For example, while series of acts have been described with regard to the processes illustrated in FIG. 10, the order of the acts may be modified according to other embodiments. Further, non-dependent acts may be performed in parallel. Additionally, other processes described in this description may be modified and/or non-dependent operations may be performed in parallel.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above-mentioned description is to be considered exemplary, rather than limiting, and the true scope of the invention is that defined in the following claims.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The terms “a,” “an,” and “the” are intended to be interpreted to include one or more items. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such.

What is claimed is:

1. A pump, comprising:
a main case having an internal gear chamber including a suction port and a discharge port;
an endplate secured to a first side of the main case;
a backplate assembly secured to a second side of the main case;
a bearing system removably disposed within the internal gear chamber, the bearing system including:
a first slug having a first bore along an axis and a first bearing disposed at least partly within the first bore, and
a second slug having a second bore along the axis; and
a drive shaft configured to extend through the internal gear chamber into the first bore and the second bore, wherein the bearing is configured to support the drive shaft,
wherein the first slug and the second slug each include an outer perimeter, in a plane orthogonal to the axis, that is configured to match a curved portion of an inner perimeter of the internal gear chamber.

2. The pump of claim 1, wherein the drive shaft includes a drive gear mounted for rotation on the drive shaft within the internal gear chamber, and
wherein a combined axial length of the bearing system and the drive gear is substantially equal to an axial length of the internal gear chamber.

3. The pump of claim 2, wherein the bearing system is removably disposed within the internal gear chamber between the endplate and the drive gear.

4. The pump of claim 2, wherein the drive shaft drives rotation of the drive gear, and wherein the drive gear drives rotation of an idler gear mounted to an idler shaft within the internal gear chamber.

5. The pump of claim 4, wherein the second slug has a substantially identical configuration to the first slug.

6. The pump of claim 2, wherein the bearing system and the drive gear have a same outer diameter.

7. The pump of claim 1, wherein the endplate is configured to be removed for extraction of the bearing system and the drive shaft.

8. The pump of claim 1, wherein the first slug is configured to be selectively inserted into the internal gear chamber with the bearing in either of an inward-facing or an outward facing orientation.

9. The pump of claim 1, wherein the first bearing includes a flanged bearing having a flange that covers a surface of the first slug, the surface being in a plane orthogonal to an axis of the first bore.

10. A system for a gear pump, comprising:
a first gear mounted for rotation on a first shaft;
a second gear mounted for rotation on a second shaft;
a first bearing assembly configured to support the first shaft within an internal gear chamber of the gear pump, the first bearing assembly including:
a first slug having a first bore along a first axis and a first outer perimeter, and
a first bearing disposed at least partly within the first bore, wherein the first bearing is configured to support the first shaft; and
a second bearing assembly configured to support the second shaft within the internal gear chamber, the second bearing assembly including:
a second slug having a second bore along a second axis and a second outer perimeter, and
a second bearing disposed at least partly within the second bore, wherein the second bearing is configured to support the second shaft,
wherein the first outer perimeter and the second outer perimeter are mated to collectively match curved portions of an inner perimeter of the internal gear chamber.

11. The system of claim 10, wherein the first bearing assembly further includes a third slug having a third bore along the first axis, wherein a combined axial length of the first bearing assembly and the first gear is substantially equal to an axial length of the internal gear chamber.

12. The system of claim 11, wherein the system is removably disposed within the internal gear chamber between an endplate and a backplate.

13. The system of claim 12, wherein the first shaft drives rotation of the first gear, and wherein the first gear drives rotation of the second gear mounted to the second shaft within the internal gear chamber.

14. The system of claim 10, wherein the first bearing assembly has an identical configuration to the second bearing assembly.

15. The system of claim 10, wherein the first bearing includes one of a rolling element bearing, a plain journal bearings, or a flanged journal bearing.

16. The system of claim 10, wherein the first bearing assembly is configured to be selectively inserted into the internal gear chamber with the first bearing in either of an inward-facing or an outward facing orientation and in either of an upward facing or downward facing orientation.

17. A method for reconfiguring a gear pump, the method comprising:
disconnecting an endplate from a main case of the gear pump;
removing internal components from a gear chamber of the main case;
inserting a replacement assembly into the gear chamber of the main case, wherein the replacement assembly includes:
a first gear mounted for rotation on a first shaft,
a second gear mounted for rotation on a second shaft,
a first bearing assembly configured to support the first shaft within the gear chamber, the first bearing assembly including a first slug having a first bore along a first axis and a first outer perimeter, and a first bearing disposed at least partly within the first bore, wherein the first bearing is configured to support the first shaft, and
a second bearing assembly configured to support the second shaft within the gear chamber, the second bearing assembly including a second slug having a second bore along a second axis and a second outer perimeter and a second bearing disposed at least partly within the second bore, wherein the second bearing is configured to support the second shaft; and
securing the endplate to the case.

18. The method of claim 17, further comprising:
selecting the replacement assembly from two or more assemblies that provide different operating parameters for the gear pump.

19. The method of claim 17, wherein the first bearing assembly further includes a third slug having a third bore along the first axis and the second bearing assembly further includes a fourth slug having a fourth bore along the second axis, and
wherein inserting the replacement assembly into the gear chamber includes:
inserting the third slug and the fourth slug into the gear chamber,
inserting the first shaft into the third bore,
inserting the second shaft into the fourth bore,
intermeshing the first gear with the second gear in the gear chamber,
inserting the first slug over the first shaft and into the gear chamber, and
inserting the second slug over the second shaft and into the gear chamber.

20. A composite slug-bearing for a gear pump, comprising:
a slug having a bore formed along an axis; and
a bearing disposed at least partly within the bore, wherein the bearing is configured to support a rotating shaft,
wherein the slug includes an outer perimeter configured to match a curved portion of an inner perimeter of an internal gear chamber of the gear pump,
wherein the composite slug-bearing is configured to be interchangeably positioned, within the internal gear chamber, facing upward or downward and inward or outward to support the rotating shaft.
